(19) United States
(12) Patent Application Publication
(10) Pub. No.: US 2007/0222953 A1
(43) Pub. Date: Sep. 27, 2007

(54) Determining the Displacement of Micromirrors in a Projection System

(75) Inventors: Gerhard Bock, Landsberg (DE); Gunter Schrepfer, Taufkirchen (DE); Marco Werner, Munchen (DE)

Correspondence Address: BELL, BOYD & LLOYD, LLP, P.O. Box 1135, CHICAGO, IL, 60690, US

(73) Assignee: BENQ MOBILE GMBH & CO. OHG, MUENCHEN GERMANY (DE)

(21) Appl. No.: 10/599,515

(22) PCT Filed: Dec. 7, 2004
(86) PCT No.: PCT/EP04/53312

§ 371 Date: Sep. 29, 2006

(30) Foreign Application Priority Data
Apr. 1, 2004 (EP) 04008022.8

(51) Int. Cl. G02B 26/12; G03B 21/28

(52) U.S. Cl. 353/98; 356/614; 359/237

(57) ABSTRACT

A projection system including a light source, such as laser light source, wherein a projection light beam is generated by means of an oscillating mirror starting from the light source. At least one light sensor is provided in the marginal zone of the projection light beam for detecting the position of the oscillating mirror.

### FIELD OF TECHNOLOGY

The present disclosure relates generally to a projection system, and in particular a laser projection system that is preferably used in miniaturized projection appliances.

### BACKGROUND

As a result of the general miniaturization of mobile appliances and the continuously growing data set to be displayed, it will become increasingly more difficult in future to cope with both these trends, for example in a mobile telephone. However, studies performed by the applicant regarding the miniaturization of projection appliances for use in conjunction with mobile telephones have demonstrated novel configurations for mitigating these difficulties.

### SUMMARY

Under an exemplary embodiment, laser beam projections are deflected by a micromirror in a mini projector. Here, the beam scans the projection area line by line, in a way similar to the electrode beam in a cathode ray tube.

The design and mode of operation of such a micromirror, or more generally microactuator, are described briefly in the following text.

In order to produce microactuators, techniques are preferably employed similar to the manufacture of microelectronic components in silicon planar technology and permit cost-effective manufacture. This includes, in particular, deposition processes for producing layers, photolithographic processes for transferring structures and etching processes for structuring. Using the monolithic or hybrid combination of micromechanically manufactured actuators and the corresponding integrated electronic actuation and signal processing yields a microsystem with extremely small dimensions, greater reliability and further-developed or novel functions as compared to conventional systems.

The use of actuators which can be operated at IC-compatible voltages is a prerequisite for the production of such a microsystem, in particular if the intention is for these systems to cope with being used in mobile appliances.

In general, a micromechanical scanner mirror is understood to mean a microactuator which is used to deflect light in a controlled manner. In order to achieve as large a degree of miniaturization as possible, these actuators are no longer produced using conventional precision-mechanical production methods; it is, rather, the abovementioned methods for microstructuring that are used.

The basic design of such an actuator comprises reflecting mirror plate suspended on a frame surrounding the mirror area using torsion or bending springs. Of the multiplicity of actuation options, the following excitation network, without limitations, may be used:

Magnetic Excitation

Here, a current is impressed in a conductor loop applied to the mirror area. If the current flow in the conductor loop changes, a twisting moment acting on the mirror plate is produced by the magnetic field applied from the outside.

Thermomechanical Excitation

In order in this method to force the actuator to displace, the mirror area preferably is suspended using two bimetal strips.

The current is conducted outward via one strip and back via the other in order to heat them.

Piezoelectric Excitation

The transversal piezoelectric effect can be used to displace a mirror plate. The piezoelectric layer lies between two electrodes. When voltage is applied, a mechanical stress is transferred to the front part of the mirror plate and causes deformation within this area. Depending on the sign of the voltage U, displacement thus takes place upward or downward.

Electrostatic Excitation

This actuation principle is sometimes the most frequently described method of using these micromechanical scanner mirrors. The method is based on the electrostatic attraction of electrode and counter-electrode when voltage is applied. By way of example, in a 1D scanner mirror, the reflecting mirror plate itself is an electrode and two counter-electrodes are formed by a layer underneath the plate.

The form of excitation for electrostatic deflection of the micromirrors can be divided roughly into two groups based on the different fields of use.

The first group includes mirrors for the quasistatic deflection of light, as is frequently the case in lasers for material processing. Since the permanent displacement of the mirror depends on the level of the voltage applied, arbitrarily low oscillation frequencies can also be implemented thereby.

Mirrors for the continuous harmonic deflection of light form the second group. This form of actuation is predominantly used in read systems for bar codes.

The excitation of the mirror oscillation can occur here in resonance, with greater displacement angles than in the quasistatic excitation being able to be attained in accordance with the mechanical Q of the system. The oscillation frequencies here depend on the mechanical structure, and range from several 100 Hz to several 10 kHz.

Suspending a 2D scanner mirror by means of a universal joint permits the combination of the advantages of the two types of actuation in one chip. The mirror plate itself here executes the quick resonant movement and is secured on an internal frame via two silicon torsion springs. Said internal frame executes the slow, quasistatic oscillation and is in turn connected to an external frame via two nickel torsion springs.

Modulating the image data onto the laser beam now produces an image. This modulated laser beam is spread by the scanner mirror and projected as a light bundle.

In order to be able to modulate the image information onto the laser beam it is necessary to know the location of the projection of the laser beam. As is known from cathode ray tubes, this requires horizontal (at each start of a line) and vertical (at the start of an image) synchronization pulses derived from the mirror movement.

One problem in this prior art is the product safety in laser projectors. In the case of a stationary mirror, the projection beam leaves the projection appliance without being deflected and can thus exceed the statutory irradiation limit values. This is why it is imperative to know for certain if the mirror is oscillating. If the mirror is not oscillating, for example, the laser can be turned off. One possible method is to measure the capacitance of the oscillating micromirror to gain information on the displacement of the mirror and thus the position of the laser beam. However, since the capacitance changes are generally within the range under 1 pF, this method is very complex in terms of circuitry and inaccurate, since the superimposed high excitation voltages for the mirror strongly interfere with the measurement.

One object of the invention is to provide a projection system with a safe and reliable means for the determining the position of the oscillating micromirror.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 shows a projection system according to an exemplary embodiment with optical position detection means; and

FIG. 2 is a diagram that illustrates a relationship between a detector position and displacement using a detector signal.

### DETAILED DESCRIPTION

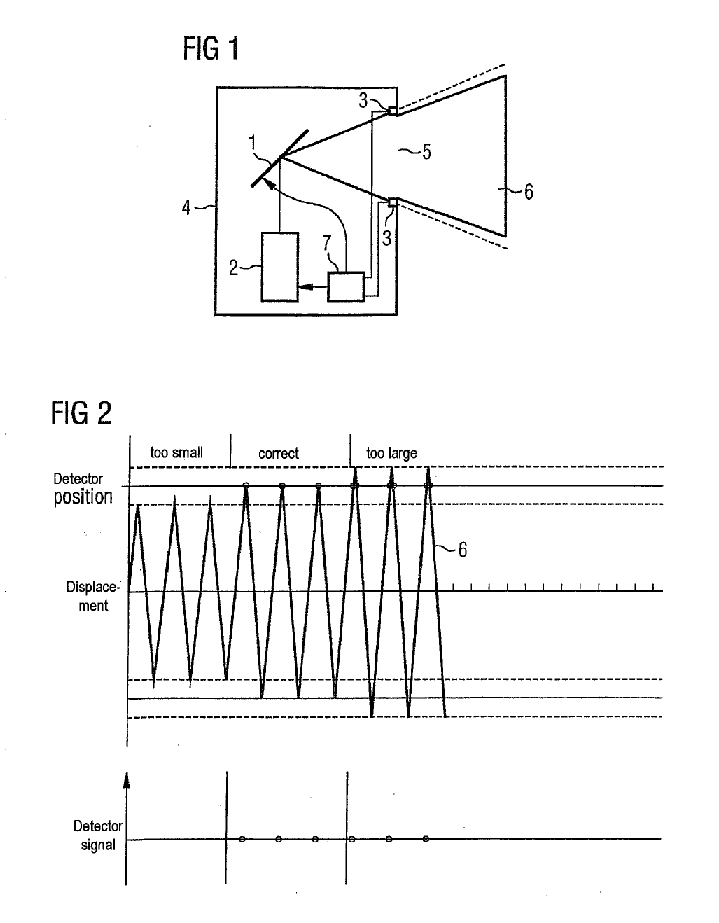

An exemplary projection system includes a laser 2 as light source and a oscillating micromirror 1 in a housing 4 as shown in FIG. 1. The light source can also be implemented by an LED or an IR-LED. The laser 2 and the oscillating mirror 1 are actuated by a control circuit 7. A laser beam directed at the mirror 1 is two-dimensionally deflected by said mirror and emitted as a projection light beam 6 or projection bundle through a projection opening 5 in the housing 4.

In accordance with the exemplary embodiment, light-sensitive components 3 give appropriate feedback to the control electronic system 7 if a light beam is incident on it, and are secured in the edge region of the projection light beam 6. Since the geometry of beam steering is known, these pulses can be used to detect the position of the mirror 1 and to determine whether the mirror 1 is oscillating.

For implementation purposes, light-sensitive sensors 3 are secured on the edges of the projection opening 5 inside the projection housing 4. By way of example, these may be CCD/CMOS sensors or other photoelements. If the projection beam strikes one of the sensors 3, the latter supplies a pulse that is used in the control circuit 7 as a synchronization signal and thus to determine position so as to control the micro mirror 1.

In FIG. 1, sensors 3 are secured on both sides of the projection opening 5. It is also possible that a single photoelement 3 on one side is adequate, depending on the projection method.

An arrangement in which the angle between the light beam emitted by the laser 2 and the projection light beam 6 is approximately 90° is also shown in FIG. 1. An arrangement in which the laser 2 is located near the projection opening 5 is also possible. Here the angle between the light beam emitted by the laser 2 and the projection light beam 6 is approximately 30 degrees.

One advantage of the projection system according to the embodiment is that the projection beam is at the same time used to determine position. Thus it is also possible during a projection to constantly monitor whether the mirror is oscillating.

If the intention is to determine outside a projection operation whether the mirror is oscillating, for example after switching on the projector, the laser needs to be operated at reduced output for this purpose, so as to avoid exceeding the radiation protection limit values. The output can be reduced, for example, by a pulse width modulation of the laser beam.

In a further development of the invention, the actual mirror position is measured by photoelectric elements or light-sensitive sensors 3 at the image edge and using a brightness modulation of the light source. This modulation can be a random pattern or else a regular signal with a specific characteristic. The modulation is controlled in the control circuit 7.

The characteristic can here be determined, for example, by a counter content or a line number. It is reasonable if the modulation of the projection light bundle 6 in the steady state is used only outside the active area in the image edge.

FIG. 2 shows the chronological sequence of the projection light bundle 6, for example at the projection opening 5, and a detector signal generated in the sensor 3. As can be seen in the self-explanatory illustration, the detector signal is changed at a detector position by the sensor 3 as a function of the displacement of the projection beam 6. The controller 7 can then appropriately control the oscillation amplitude of the mirror 1, that is to say increase or reduce it as required.

The aim of the further development is the temporal detection of the position of the light beam 6 with respect to photoelectric elements, which generally do not just capture a pixel with simple effort, but an area of pixels in a plurality of lines. Correlating the modulation signal with the received signal allows for the exact position of the image segment with respect to these calibration receivers to be determined in order to thereby synchronize the projection device and to accurately adjust the image size.

The modulation signal can furthermore be used in order to keep the power density of the light beam low during startup as long as the spreading by means of the deflection of the oscillating mirrors is not yet ensured.

The further development of the invention yields a better synchronization of the oscillating mirror 1 and therefore a more accurate image size adjustment in deflection mirror projection systems. It furthermore permits safe startup and constant surveillance of the deflection function to avoid an excessively great and thus dangerous power density of the light beam.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

1-2. (canceled)

3. A projection system comprising:
an oscillating mirror;
a laser light source, wherein a projection light bundle is produced starting from the light source using the oscillating mirror, and wherein by at least one light sensor is arranged at the edge region of the projection light bundle and detects the position of the oscillating mirror.

4. The projection system as claimed in claim 3, wherein the brightness of the projection light bundle is modulated at least in a partial region of an image to be projected and the position of the oscillating mirror is determined by correlating the modulation of the projection light bundle and of a detector signal from the light sensor.

5. A method for operating a projection system, comprising:
obtaining a brightness level from a light sensor;
modulating the brightness at least in a partial region of an image to be projected in the projection system; and
detecting the oscillation status and position of an oscillating mirror using the light sensor.

6. The method according to claim 5, wherein the position of the oscillating mirror is determined by correlating the modulation with a detector signal generated from the light sensor.
